(19) United States
(12) Patent Application Publication
(10) Pub. No.: US 2025/0111631 A1
(43) Pub. Date: Apr. 3, 2025

(54) USER PERCEIVED FORWARD DETERMINATION BASED ON DETECTED HEAD CENTER

(71) Applicant: Apple Inc., Cupertino, CA (US)

(72) Inventor: Nahckjoon Kim, Sunnyvale, CA (US)

(21) Appl. No.: 18/794,365

(22) Filed: Aug. 5, 2024

Related U.S. Application Data
(60) Provisional application No. 63/540,998, filed on Sep. 28, 2023.

(51) Int. Cl. G06T 19/20; H04N 13/344; H04N 13/383

(52) U.S. Cl. CPC G06T 19/20; H04N 13/344; H04N 13/383; G06T 2219/2016

(57) ABSTRACT

Various implementations disclosed herein include devices, systems, and methods that present a view with content at a 3D position within a 3D environment based on determining a difference between a user-specific forward direction and a head-mounted device (HMD)-forward direction. For example, a process may present a view of a content item at a position and an orientation within a three-dimensional (3D) environment. The process may further obtain a first change to the orientation of the content item within the 3D environment and a second change to the position of the content item with the 3D environment. The process may further determine a characteristic of a user-specific forward direction based on the first change and the second change and present additional content within one or more 3D environments based on the characteristic of the user-specific forward direction.

### CROSS-REFERENCE TO RELATED APPLICATIONS

This Application claims the benefit of U.S. Provisional Application Ser. No. 63/540,998 filed Sep. 28, 2023, which is incorporated herein in its entirety.

### TECHNICAL FIELD

The present disclosure generally relates to presenting a content view, via electronic devices such as head-mounted devices (HMDs), at a specified position within an extended reality (XR) environment based on determining a difference between a user-perceived or specific forward direction and an HMD-forward direction.

### BACKGROUND

Existing techniques for presenting content via wearable electronic devices may not adequately account for non-symmetrical human facial geometry and may be improved with respect to providing a content view that is consistent with a user perceived forward directional view.

### SUMMARY

Various implementations disclosed herein include devices, systems, and methods that present a view with content at a 3-dimensional (3D) position within a 3D environment based on determining a difference between a user-perceived (e.g., user specific) forward direction and an HMD-forward direction. Some implementations determine the difference or mismatch between a user-perceived forward direction and an HMD-forward direction based on a manual tuning process. A manual tuning process may include initially spawning content, such as a virtual window or application interface, for presentation to a user. Subsequent to initially spawning the content, the user may be instructed to rotate and/or shift in a specified direction such as, inter alia, left or right, the content to a desired position and/or orientation utilized to determine the difference or mismatch between the user-perceived forward direction and the HMD-forward direction. In some implementations, the initially spawned content may comprise eye-based content. In some implementations the initially spawned content may comprise device-based content.

In some implementations, an eye center position between the eyes of a user wearing the HMD may be determined. Likewise, an eye forward direction may be determined based on the eye center position. In some implementations, the desired position and/or orientation for the content is determined based on the determined eye-forward direction.

In some implementations, presenting a view of a content item at the desired position and orientation may include determining a device-forward direction and determining the desired position and the orientation based on the device-forward direction.

In some implementations, the user may be instructed to rotate the content to a desired position by instructing the user to rotate a content item until the content item appears to the user to be facing the user. An original vector used to determine the orientation of the content item may be rotated until the original vector is located parallel to a user perceived forward vector.

In some implementations, instructing the user to shift the content to a desired orientation may include instructing the user to shift the content item in a left or right direction until the content item appears to the user to be centered in front of the user.

In some implementations, a view with content is presented at a 3D position within a 3D environment (XR) in response to determining a difference between a user-perceived forward direction and an HMD-forward direction based on determining an eye-forward direction determined with respect to an eye center position. An eye center position may be determined with respect to an anatomical center position for each eye of the user. An eye-forward direction may be determined by projecting a normal from the eye center. In some implementations, the eye-forward direction may be adjusted to account for asymmetry within facial geometry of a user.

In some implementations, a device such as an HMD has a processor (e.g., one or more processors) that executes instructions stored in a non-transitory computer-readable medium to perform a method. The method performs one or more steps or processes. In accordance with some implementations, the device obtains a first change to the orientation of the content item within the 3D environment. In accordance with some implementations, the device obtains a second change to the position of the content item with the 3D environment. In accordance with some implementations, the device determines a characteristic of a user-specific forward direction based on the first change to the orientation and the second change to the position of the content item. In accordance with some implementations, the device presents additional content within one or more 3D environments based on the characteristic of the user-specific forward direction.

In some implementations, a device such as an HMD has a processor (e.g., one or more processors) that executes instructions stored in a non-transitory computer-readable medium to perform a method. The method performs one or more steps or processes. In accordance with some implementations, the device determines an eye center based on detected eyeball locations calculated using sensor data from one or more sensors of the device. The eye center may be a center position between eyes of a user wearing the device. In accordance with some implementations, the device determines an eye-forward direction based on the eye center. In accordance with some implementations, the device determines a characteristic of a user-specific forward direction based on the eye-forward direction and presents content within one or more 3D environments based on the characteristic of the user-specific forward direction.

In some implementations, a device such as an HMD has a processor (e.g., one or more processors) that executes instructions stored in a non-transitory computer-readable medium to perform a method. The method performs one or more steps or processes. In accordance with some implementations, the device presents a view of passthrough content with respect to a position associated with a forward view. In accordance with some implementations, the device obtains input indicating an angular difference between a forward based direction and a body position direction of a user of the device viewing the passthrough content. In accordance with some implementations, the device obtains input indicating a translational difference between the forward based direction and the body position direction of the user of the HMD viewing the passthrough content. In response to detecting the user of the HMD performing a specific motion, the device may determine a characteristic of a user-specific forward direction based on the angular difference and the translational difference and content may be presented within one or more 3D environments based on the characteristic of the user-specific forward direction.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an exemplary electronic device operating in a physical environment in accordance with some implementations.

FIG. 2 illustrates a view of an eye-based estimation approach for determining a difference between a user-perceived forward direction and an HMD-forward direction, in accordance with some implementations.

FIG. 3 illustrates views of an eye-based manual tuning estimation process for determining a difference between a user-perceived forward direction and an eye-based forward direction, in accordance with some implementations.

FIG. 4 illustrates a view of a calibration stage implemented during a device setup process for performing an automatic alignment offset calculation, in accordance with some implementations.

FIG. 5 illustrates views of a device-based manual tuning estimation process for determining a difference between a user-perceived forward direction and device-based forward direction, in accordance with some implementations.

FIG. 6A is a flowchart representation of an exemplary method that performs a manual tuning estimation process for determining a difference between a user-perceived forward direction and an eye-based or device-based forward direction, in accordance with some implementations.

FIG. 6B is a flowchart representation of an exemplary method that performs an eye-based estimation approach for determining a difference between a user-perceived forward direction and an HMD-forward direction, in accordance with some implementations.

FIG. 6C is a flowchart representation of an exemplary method that executes an explicit calibration stage during a setup procedure for an automatic alignment offset determination, in accordance with some implementations.

FIG. 7 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

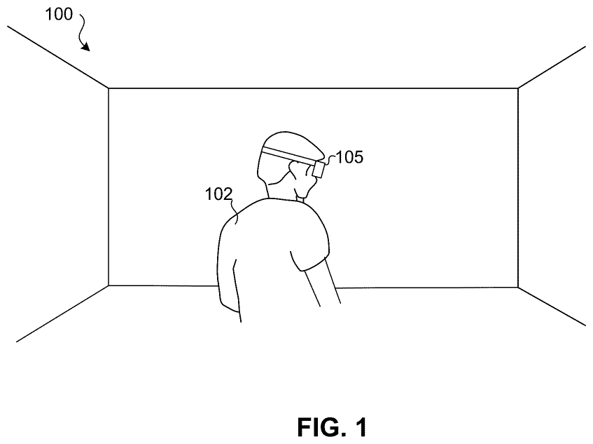

FIG. 1 illustrates an exemplary electronic device 105 operating in a physical environment 100. In the example of FIG. 1, the physical environment 100 is a room. The electronic device 105 may include one or more cameras, microphones, depth sensors, or other sensors that can be used to capture information about and evaluate the physical environment 100 and the objects within it, as well as information about the user 102 of electronic device 105. The information about the physical environment 100 and/or user 102 may be used to provide visual and audio content and/or to identify the current location of the physical environment 100 and/or the location of the user within the physical environment 100.

In some implementations, views of an extended reality (XR) environment may be provided to one or more participants (e.g., user 102 and/or other participants not shown) via electronic device 105 (e.g., a wearable device such as an HMD). Such an XR environment may include views of a 3D environment that is generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system (i.e., a 3D space) associated with the XR environment, which may correspond to a 3D coordinate system of the physical environment 100.

In some implementations, a view of an object such as a 2-dimensional (2D) window is presented at a position and an orientation within a 3D environment. For example, a 3D configuration (e.g., a pose) of the content item may be determined based on an eye-center-based forward position, a device-based forward position, etc. In some implementations, a first change to the orientation (e.g., yaw) of the object within the 3D environment and a second change to the position (e.g., sway) of the object with the 3D environment are obtained. In response, a characteristic of a user-perceived (or user specific) forward direction may be determined based on the first change to the orientation and the second change to the position of the content item. The characteristic may comprise any type of characteristic related to a user-perceived forward direction. For example, the characteristic may include a mismatch between the device-based forward direction and the user-perceived forward direction. Subsequently, an additional object may be presented within at least one 3D environment based on the characteristic of the user-perceived forward direction.

Some implementations present the view of the object at the position and orientation by determining an eye center (e.g., a position between eyes of a user wearing an HMD) based on detected eyeball locations calculated using sensor data from sensors of the HMD; determining an eye-forward direction based on the eye center; and determining the position and the orientation based on the eye-forward direction.

Some implementations present the view of the object at the position and orientation by determining a device-forward direction and determining the position and the orientation based on the device-forward direction.

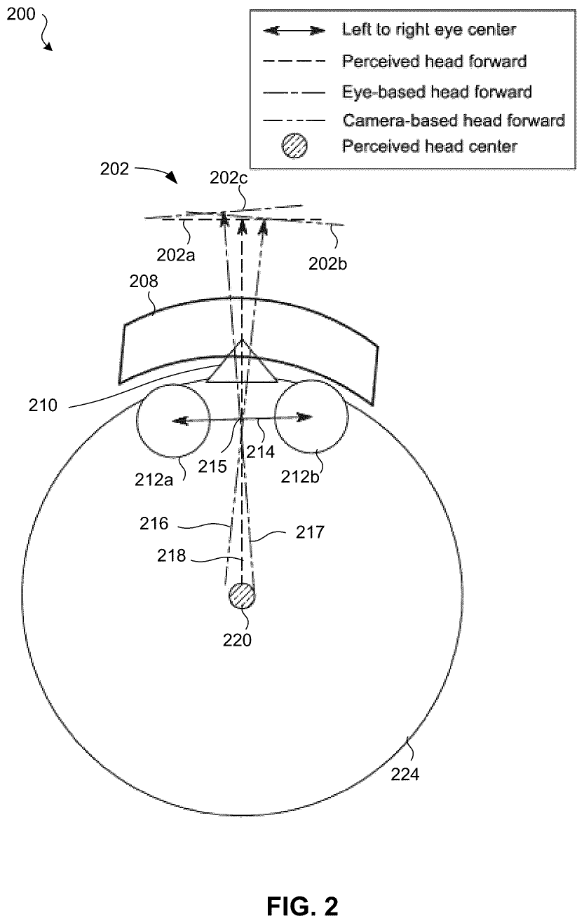

FIG. 2 illustrates a view 200 of an eye-based estimation approach for determining a difference (e.g., mismatch) between a user-perceived (or user specific) forward direction and an HMD-forward direction projected to an application interface 202 based on determining an eye-forward direction. The user-perceived forward direction is illustrated by vector 218 projected to an application interface 202 at a position and orientation 202a. The HMD-forward direction is illustrated by vector 216 projected to application interface 202 at a position and orientation 202b. The eye-forward direction is illustrated by vector 217 projected to application interface 202 at a position and orientation 202c.

In the example illustrated in FIG. 2, an eye center position 215 located on a vector 214 projected between a user's eyeballs 212a and 212b may be determined based on a position(s) of an anatomical center of the user's eyeballs 212a and 212b(e.g., with respect to a head 224 and a nose 210 of a user) as illustrated in FIG. 2. Subsequently, the eye-forward direction projected to application interface 202 may be determined by projecting a normal (with respect to vector 214 extending through eye center position 215) from the determined eye center position 215. The normal may be initially projected from a perceived (or specific) center 220 of the user's head 224. The eye-forward direction may be used to provide an estimate of the user perceived head forward direction projected to application interface 202. Eye center position 215 may be determined based on detected eyeball locations calculated using sensor data from one or more sensors of HMD 208. In some implementations, eye-forward direction may be adjusted to account for asymmetry in facial geometry. In some implementations, content may be presented within one or more 3D environments based on the difference between user-perceived forward direction and HMD-forward direction.

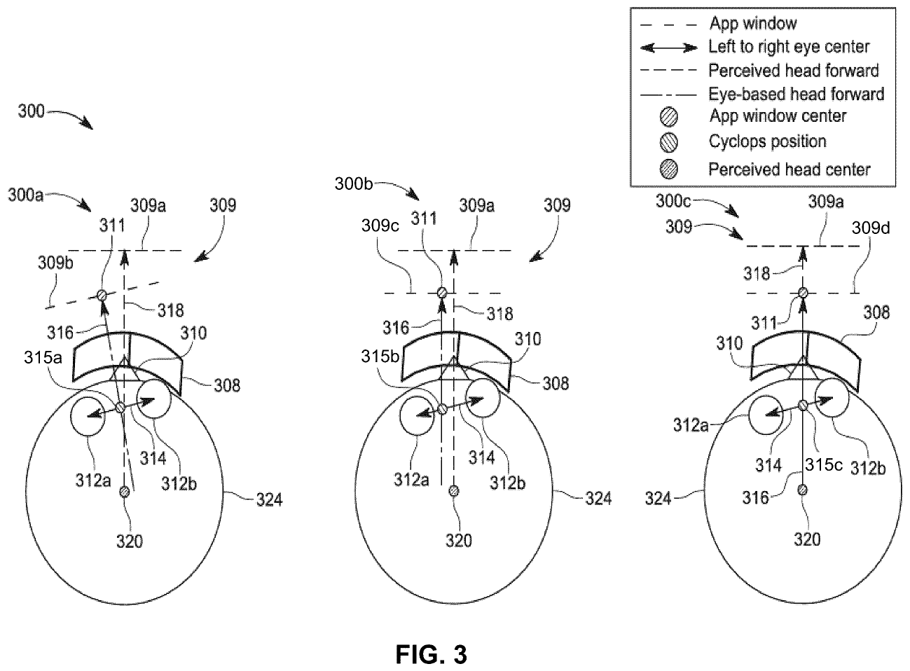

FIG. 3 illustrates views 300 (e.g., view 300a, view 300b, and view 300c) of an eye-based manual tuning estimation process for determining a difference between a user-perceived forward direction and an eye-based forward direction associated with a position of the user's eyes. The user-perceived forward direction is illustrated by vector 318 projected to an application interface 309 at a position and orientation 309a. The eye-based forward direction is illustrated by vector 316 projected to application interface 309 at a position and orientation 309b. The views 300a, 300b, and 300c illustrate manual movement of application interface 309 to obtain sufficient alignment characteristics for presenting content via application interface 309.

In the example of FIG. 3, at a first instance in time corresponding to view 300a, a default condition is enabled such that application interface 309 is spawned with respect to the eye-based forward direction. Application interface 309 may be initially spawned with respect to an offset position and orientation (position/orientation 309b comprising an application interface center point 311), such as a tilt position, based on a facial geometry of a user and a position or fit of an HMD 308 (or any type of wearable device) with respect to the user. Therefore, an eye-based manual tuning estimation approach is enabled for determining a difference between the eye-based forward direction and the user-perceived forward direction.

In the example illustrated in view 300a, an initial cyclops position 315a may be determined based on a midpoint between eyeballs 312a and 312b (e.g., with respect to a nose 310 and/or a head 324 of a user) along vector 314. Likewise, vector 316 may be determined based on a direction normal to vector 314 and positioned to intersect with initial cyclops position 315a as illustrated in view 300a. Initial cyclops position 315a may be determined based on detected eyeball locations calculated using sensor data from one or more sensors of HMD 308.

In the example of FIG. 3, at a second instance in time corresponding to view 300b, instructions for directing the user to provide a first change to an orientation of application interface 309 are presented to the user. In response to the instructions, the user rotates the application interface 309 to an orientation 309c such that application interface 309 faces the user viewpoint. For example, the user may rotates the application interface 309 to an orientation 309c such that application interface 309 appears to be facing the user. The rotation process may initialize an internal process that includes the user rotating application interface 309 to a position that appears to be facing the user and a resulting position of the rotation results in causes vector 316 to reach a position that is parallel to vector 318. In response, with respect to counteracting a translational offset created by rotating vector 316, initial cyclops position 315a is automatically shifted to a position 315b to maintain a same or similar position for application interface 309.

In the example of FIG. 3, at a third instance in time corresponding to view 300c, instructions directing the user to provide a second change the position of the application interface 309 are presented to the user. In response, the user shifts (left or right) the application interface 309 to a position 309d that the user perceives as centered and in front of the user. In an alternative embodiment, the shifting process may include automatically moving (via device) position 315b to a position 315c to shift vector 318 to match the user's perception of being centered. Subsequently, content is presented to the user via application interface 309 with respect to a user-perceived forward direction.

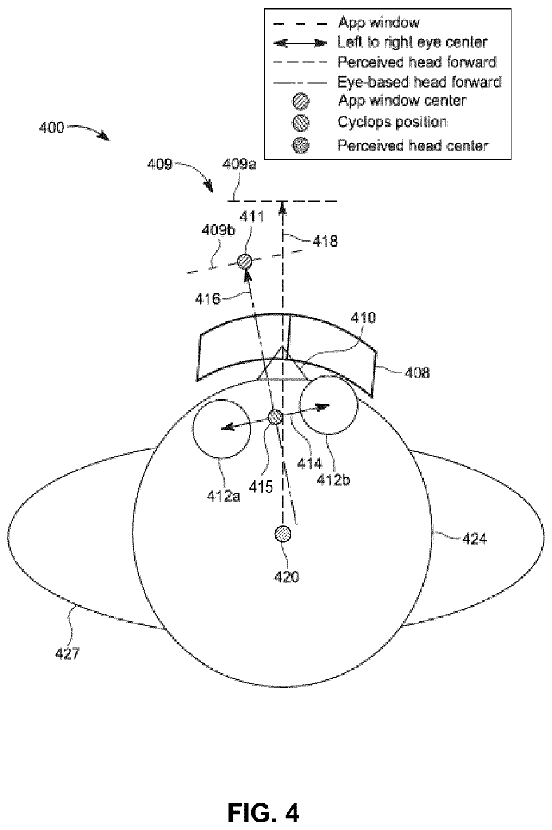

FIG. 4 illustrates a view 400 of a calibration stage implemented during a device, such as an HMD 408, setup process for performing an automatic alignment offset calculation. During the device setup process, instructions directing the user to perform explicit calibration steps are presented to the user. Executing the explicit calibration steps enable the device to automatically calculate an amount of change in rotation and translation necessary to enable an eye-based forward direction to match a user perceived forward direction. The user-perceived forward direction is illustrated by vector 418 projected to an application interface 409 at a position and orientation 409a. The eye-based forward direction is illustrated by vector 416 projected to application interface 409 at a position and orientation 409b comprising an application interface center point 411.

In the example illustrated in view 400, an initial cyclops position 414a is positioned at a location where a vector 414 projected between the user's eyeballs 412a and 412b converges with vector 416. The initial cyclops position 414a may be determined based on a position(s) of an anatomical center of the user's eyeballs 412a and 412b (e.g., with respect to a nose 410 and/or a head 424 of a user) as illustrated in view 400. Initial cyclops position 5 may be determined based on detected eyeball locations calculated using sensor data from one or more sensors of HMD 408

The device setup process utilizes passthrough content without providing virtual content. During the device setup process, instructions directing the user to look forward are presented to the user. In response, an angular and translational delta between vector 416 and a body pose vector (not illustrated) closely matching vector 418 is collected. Subsequently, the user is instructed to perform a specific motion(s) while keeping their body still. For example, the user may be instructed to turn their head left/right/up/down, rotate their head in a circular motion, etc. While the user is performing the specific motion, a convergence point associated with vector 416 is calculated for determining a head pivot point 420 for the user.

Alternatively, head pivot point 420 may be determined by tracking the convergence point associated with vector 416 even if it does not match the user-perceived forward direction.

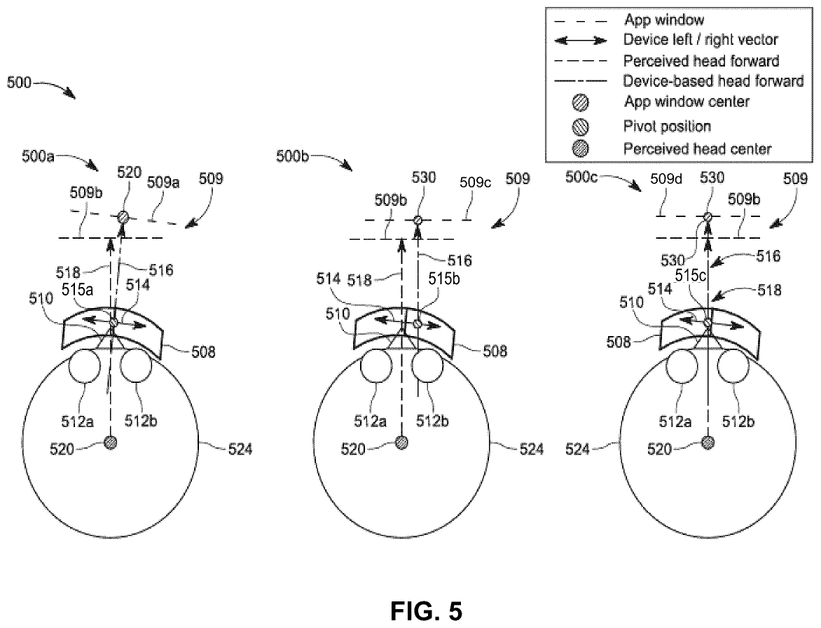

FIG. 5 illustrates views 500 (e.g., view 500a, view 500b, and view 500c) of a device-based (as opposed to an eye-based) manual tuning estimation process for determining a difference between a user-perceived forward direction and device-based forward direction associated with a position of the device 508. In contrast to the eye-based manual tuning process illustrated in views 300a, 300b, and 300c of FIG. 3, views 500a, 500b, and 500c of FIG. 5 illustrate a device-based manual tuning process that determines a device-forward direction to determine a position and orientation of a content item (e.g., a 2D window) within a 3D environment. Likewise, views 300a, 300b, and 300c of FIG. 3 illustrate a device 308 aligned properly with a horizontal axis (or properly positioned on the user's face) but eyeballs 312a and 312b are positioned at an angle with respect to the horizontal axis thereby contrasting with views 500a, 500b, and 500c of FIG. 5 illustrating eyeballs 512a and 512b being aligned with the horizontal axis but device 508 not being centered with respect user's face.

The user-perceived forward direction is illustrated by vector 518 projected to an application interface 509 at a position and orientation 509b. The device-based forward direction is illustrated by vector 516 projected to application interface 509 at a position and orientation 509a. The views 500a, 500b, and 500c) illustrate manual movement of application interface 509 to obtain sufficient alignment characteristics for presenting content via application interface 509.

In the example of FIG. 5, at a first instance in time corresponding to view 500a, a default condition is enabled such that application interface 509 is spawned with respect to the device-based forward direction. Application interface 509 may be initially spawned with respect to an offset position and orientation (position/orientation 509a comprising an application interface center point 520), such as a tilt position, based on a facial geometry of a user and a position or fit of an HMD 508 (or any type of wearable device) with respect to the user. Therefore, a device-based manual tuning estimation approach is enabled for determining a difference between the device-based forward direction and the user-perceived forward direction without utilizing any information associated with eyeballs 512a and 512b, nose 510 and/or a head 524 of a user.

In the example illustrated in view 500a, an initial pivot position 514515a defined by an initial position of HMD 508 is positioned at a location where a (left/right) vector 514 projected within HMD 508 converges with vector 516. Initial pivot position 515a is determined based on an initial fit of HMD with respect to a facial geometry of the user. Vector 514 comprises a vector that is projected between external portions of HMD 508 with respect to a left and right direction.

In the example of FIG. 5, at a second instance in time corresponding to view 500b, instructions for directing the user to provide a first change to an orientation of application interface 509 are presented to the user. In response to the instructions, the user rotates the application interface 509 to an orientation 509c such that application interface 509 faces the user viewpoint. The rotation process may initialize an internal process that includes rotating vector 516 until it reaches a position that is parallel to vector 518. In response, with respect to counteracting a translational offset created by rotating vector 516, pivot position 515a is automatically shifted to a position 515b to maintain a same or similar position for application interface 509.

In the example of FIG. 5, at a third instance in time corresponding to view 500c, instructions directing the user to provide a second change to the position of the application interface 509 are presented to the user. In response, the user shifts (left or right) the application interface 509 to a position 509d that the user perceives as centered and in front of the user. The shifting process may include automatically moving position 515b to a position 515c to shift vector 518 to match the user's perception of being centered. Subsequently, content is presented to the user via application interface 509 with respect to a user-perceived forward direction.

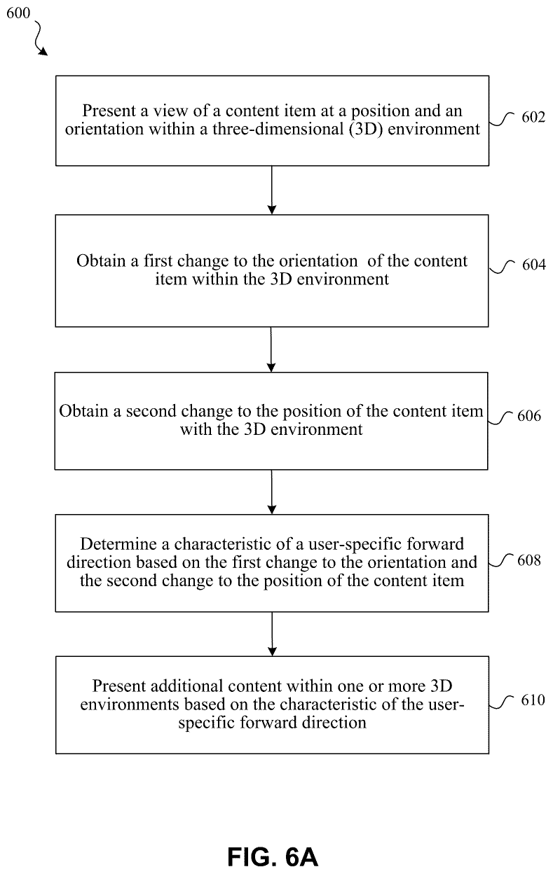

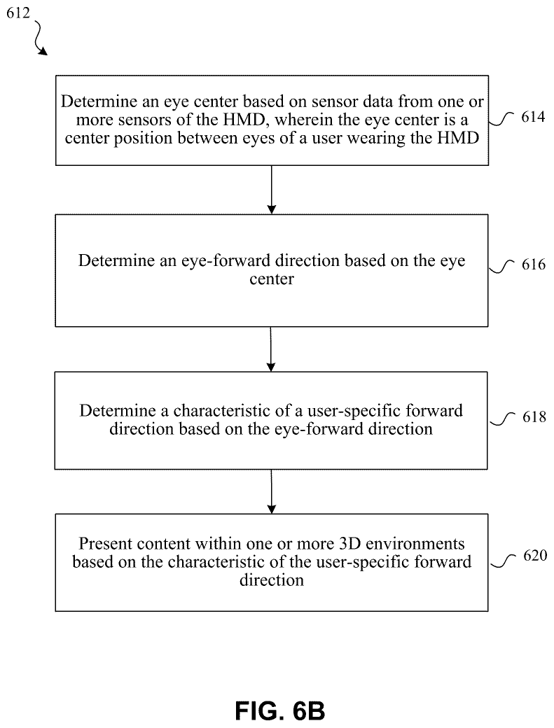

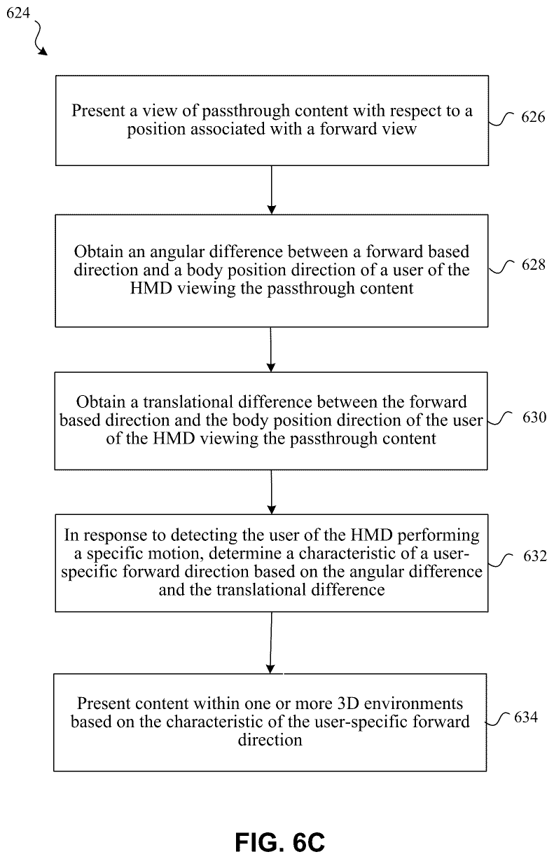

FIG. 6A is a flowchart representation of an exemplary method 600 that performs a manual tuning estimation process for determining a difference between a user-perceived forward direction and an eye-based or device-based forward direction, in accordance with some implementations. In some implementations, the method 600 is performed by a device, such as a mobile device, desktop, laptop, HMD, or server device. In some implementations, the device has a screen for displaying images and/or a screen for viewing stereoscopic images such as a head-mounted display (HMD such as e.g., device 105 of FIG. 1). In some implementations, the method 600 is performed by processing logic, including hardware, firmware, software, or a combination thereof. In some implementations, the method 600 is performed by a processor executing code stored in a non-transitory computer-readable medium (e.g., a memory). Each of the blocks in the method 600 may be enabled and executed in any order.

At block 602, the method 600 presents a view of a content item (e.g., a 2D window) at a position and an orientation within a three-dimensional (3D) environment. The content item may include a 2D window such as, inter alia, an application interface such as application interface 309 as described with respect to FIG. 3, etc.

In some implementations, presenting the view of the content item at the position and the orientation may include an eye-center-based forward position presentation method such that an eye center position is determined based on detected eyeball locations calculated using sensor data from one or more sensors of an HMD. The eye center position comprises a center position between eyes of a user wearing the HMD. Subsequently, an eye-forward direction is determined based on the eye center position and the position and orientation are determined based on the eye-forward direction.

In some implementations, presenting the view of the content item at the position and the orientation may include a device-center-based forward position presentation method such that a device-forward direction is determined and the position and the orientation of the content item are determined based on the device-forward direction. For example, a device-center-based forward direction illustrated by vector 516 projected to application interface 509 at a position and orientation 509a as described with respect to FIG. 5.

At block 604, the method 600 obtains a first change to the orientation (e.g., yaw) of the content item within the 3D environment. For example, a first change to an orientation of application interface 309 as described with respect to FIG. 3. Obtaining the first change to the orientation may include presenting an instruction for a user to rotate the content item until the content item appears to the user to be facing the user.

In some implementations, based on the first change to the orientation, an original vector used to determine the orientation of the content item may be rotated until it is parallel to a user perceived forward vector and the content item may be reoriented in the view based on the rotated original vector.

At block 606, the method 600 obtains a second change to the position (e.g., sway) of the content item within the 3D environment. For example, a second change to a position of application interface 309 as described with respect to FIG. 3. In some implementations, the first change to the orientation may be obtained before the second change to the positions. In some implementations, obtaining the second change to the position may include presenting an instruction for a user to shift the content item left or right until the content item appears to the user to be centered in front of the user.

In some implementations, based on the second change to the position of the content item, the content item may be shifted to the left or right, as discussed herein with respect to application interface 309 shifted to a position 309d that the user perceives as centered and in front of the user as described with respect to FIG. 3.

At block 608, the method 600 determines a characteristic of a user-perceived forward direction based on the first change to the orientation and the second change to the position of the content item as described with respect to FIG. 3.

In some implementations, determining the characteristic of the user-perceived forward direction may include determining a difference between a device-based forward direction and the user-perceived forward direction, as discussed herein with respect to vectors 516 and 518 as described with respect to FIG. 5.

At block 610, the method 600 presents additional content within one or more 3D environments based on the characteristic of the user-perceived forward direction.

FIG. 6B is a flowchart representation of an exemplary method 612 that performs an eye-based estimation approach for determining a difference between a user-perceived forward direction and an HMD-forward direction, in accordance with some implementations. In some implementations, the method 612 is performed by a device, such as a mobile device, desktop, laptop, HMD, or server device. In some implementations, the device has a screen for displaying images and/or a screen for viewing stereoscopic images such as a head-mounted display (HMD such as e.g., device 105 of FIG. 1). In some implementations, the method 612 is performed by processing logic, including hardware, firmware, software, or a combination thereof. In some implementations, the method 612 is performed by a processor executing code stored in a non-transitory computer-readable medium (e.g., a memory). Each of the blocks in the method 612 may be enabled and executed in any order.

At block 614, the method 600 determines an eye center based on detected eyeball locations calculated using sensor data from one or more sensors of an HMD. The eye center comprises a center position between eyes of a user wearing the HMD. For example, eye center position 215 as described with respect to FIG. 2. In some implementations, the eye center is determined based on determining anatomical centers of each of the eyes.

At block 616, the method 600 determines an eye-forward direction based on the eye center. In some implementations, the eye-forward direction is determined by projecting a normal from the eye center. For example, eye-forward direction illustrated by vector 217 as described with respect to FIG. 2. In some implementations, the eye-forward direction may be adjusted to account for asymmetry within facial geometry of the user.

At block 618, the method 600 determines a characteristic of a user-perceived forward direction based on the eye-forward direction. In some implementations, determining the characteristic of the user-perceived forward direction may include determining a difference between a device-based forward direction and the user-perceived forward direction as described with respect to view 200 of FIG. 2.

At block 620, the method 600 presents content within one or more 3D environments based on the characteristic of the user-perceived forward direction.

FIG. 6C is a flowchart representation of an exemplary method 624 that executes an explicit calibration stage during a setup procedure for an automatic alignment offset determination, in accordance with some implementations. In some implementations, the method 624 is performed by a device, such as a mobile device, desktop, laptop, HMD, or server device. In some implementations, the device has a screen for displaying images and/or a screen for viewing stereoscopic images such as a head-mounted display (HMD such as e.g., device 105 of FIG. 1). In some implementations, the method 624 is performed by processing logic, including hardware, firmware, software, or a combination thereof. In some implementations, the method 624 is performed by a processor executing code stored in a non-transitory computer-readable medium (e.g., a memory). Each of the blocks in the method 624 may be enabled and executed in any order.

At block 626, the method 624 presents a view of passthrough content with respect to a position associated with a forward view as described with respect to FIG. 4.

At block 628, the method 624 obtains an angular difference between a forward based direction and a body position direction of a user of the HMD viewing the passthrough content. For example, an angular delta between vector 416 and a body pose vector closely matching vector 418 as described with respect to FIG. 4. The forward based direction may be an eye-forward direction, a device-forward direction, etc.

At block 630, the method 624 obtains a translational difference between the forward based direction and the body position direction of the user of the HMD viewing the passthrough content. For example, a translational delta between vector 416 and a body pose vector closely matching vector 418 as described with respect to FIG. 4.

At block 632, in response to detecting the user of the HMD performing a specific motion, the method 624 determines a characteristic of a user-perceived forward direction based on the angular difference and the translational difference. For example, the user may be instructed to turn their head left/right/up/down, rotate their head in a circular motion, etc. as described with respect to FIG. 4.

At block 634, the method 624 presents content within one or more 3D environments based on the characteristic of the user-perceived forward direction.

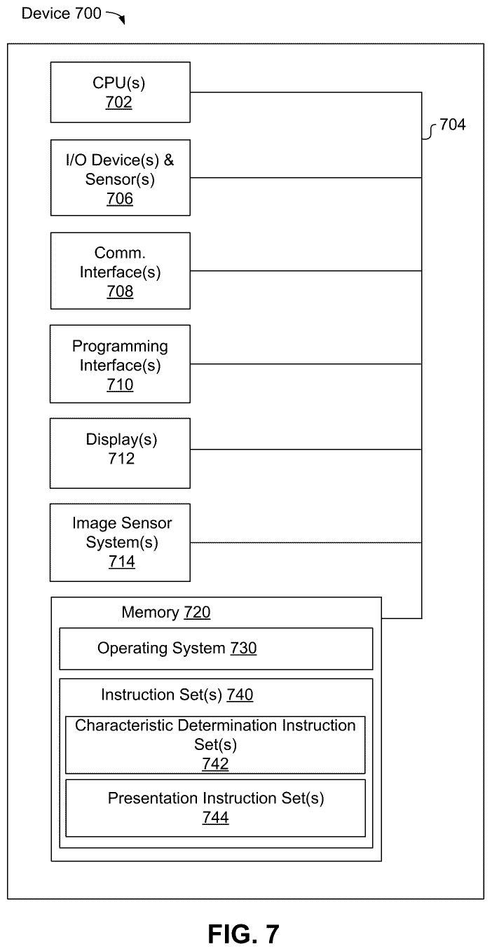

FIG. 7 is a block diagram of a device 700. Device 700 illustrates an exemplary device configuration for electronic device 105 of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 700 includes one or more processing units 702 (e.g., microprocessors, ASICs, FPGAs, GPUs, CPUs, processing cores, and/or the like), one or more input/output (I/O) devices and sensors 706, one or more communication interfaces 708 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 710, one or more output device(s) 712, one or more interior and/or exterior facing image sensor systems 714, a memory 720, and one or more communication buses 704 for interconnecting these and various other components.

In some implementations, the one or more communication buses 704 include circuitry that interconnects and controls communications between system components. In some implementations, the one or more I/O devices and sensors 706 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more output device(s) 712 include one or more displays configured to present a view of a 3D environment to the user. In some implementations, the one or more displays 712 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 700 includes a single display. In another example, the device 700 includes a display for each eye of the user.

In some implementations, the one or more output device(s) 712 include one or more audio producing devices. In some implementations, the one or more output device(s) 712 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener's brain into interpreting sounds as if the sounds occurred at the point(s) in the 3D environment (e.g., from one or more particular sound sources) even though the actual sounds may be produced by speakers in other locations. The one or more output device(s) 712 may additionally or alternatively be configured to generate haptics.

In some implementations, the one or more image sensor systems 714 are configured to obtain image data that corresponds to at least a portion of a physical environment. For example, the one or more image sensor systems 714 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 714 further include illumination sources that emit light, such as a flash. In various implementations, the one or more image sensor systems 714 further include an on-camera image signal processor (ISP) configured to execute a plurality of processing operations on the image data.

The memory 720 includes high-speed random-access memory, such as DRAM, SRAM, DDR RAM, or other random-access solid-state memory devices. In some implementations, the memory 720 includes non-volatile memory, such as one or more magnetic disk storage devices, optical disk storage devices, flash memory devices, or other non-volatile solid-state storage devices. The memory 720 optionally includes one or more storage devices remotely located from the one or more processing units 702. The memory 720 comprises a non-transitory computer readable storage medium.

In some implementations, the memory 720 or the non-transitory computer readable storage medium of the memory 720 stores an optional operating system 730 and one or more instruction set(s) 740. The operating system 730 includes procedures for handling various basic system services and for performing hardware dependent tasks. In some implementations, the instruction set(s) 740 include executable software defined by binary information stored in the form of electrical charge. In some implementations, the instruction set(s) 740 are software that is executable by the one or more processing units 702 to carry out one or more of the techniques described herein.

The instruction set(s) 740 includes a characteristic determination instruction set 742 and a presentation instruction set 744. The instruction set(s) 740 may be embodied as a single software executable or multiple software executables.

The characteristic determination instruction set 742 is configured with instructions executable by a processor to determine a characteristic of a user-perceived (or user specified) forward direction based on a change to an orientation and a change to a position of a content item such as a 2D display.

The presentation instruction set 744 is configured with instructions executable by a processor to present content within one or more 3D environments based on a characteristic of the user-perceived forward direction.

Although the instruction set(s) 740 are shown as residing on a single device, it should be understood that in other implementations, any combination of the elements may be located in separate computing devices. Moreover, the figure is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of sensor data that may include user data to improve a user's experience of an electronic device. The present disclosure contemplates that in some instances, this gathered data may include personal information data that uniquely identifies a specific person or can be used to identify interests, traits, or tendencies of a specific person. Such personal information data can include movement data, physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve the content viewing experience. Accordingly, use of such personal information data may enable calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after obtaining the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access their stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at a head-mounted device (HMD) having a processor:
presenting a view of a content item at a position and an orientation within a three-dimensional (3D) environment;
obtaining a first change to the orientation of the content item within the 3D environment;
obtaining a second change to the position of the content item with the 3D environment;
determining a characteristic of a user-specific forward direction based on the first change and the second change to the content item; and
presenting additional content within one or more 3D environments based on the characteristic of the user-specific forward direction.

2. The method of claim 1, wherein said presenting the view of the content item at the position and the orientation comprises:
determining an eye center based on sensor data from one or more sensors of the HMD, wherein the eye center is a center position between eyes of a user wearing the HMD;
determining an eye-forward direction based on the eye center; and
determining the position and the orientation, of the content item within the 3D environment, based on the eye-forward direction.

3. The method of claim 1, wherein said presenting the view of the content item at the position and the orientation comprises:
determining a device-forward direction based on a position of the HMD; and determining the position and the orientation, of the content item within the 3D environment, based on the device-forward direction.

4. The method of claim 1, wherein said determining the characteristic of the user-specific forward direction comprises determining a difference between a device-based forward direction and the user-specific forward direction.

5. The method of claim 1, wherein said determining the characteristic of the user-specific forward direction comprises determining a difference between an eye-based forward direction and the user-specific forward direction.

6. The method of claim 1, wherein the first change is obtained before the second change.

7. The method of claim 1, wherein said obtaining the first change to the orientation comprises:
presenting an instruction for a user to rotate the content item until the content item appears to the user to be facing the user.

8. The method of claim 1, further comprising:
based on the first change to the orientation, rotating an original vector used to determine the orientation of the content item; and
reorienting the content item in the view based on the rotated original vector.

9. The method of claim 1, wherein said obtaining the second change to the position comprises:
presenting an instruction for a user to shift the content item left or right until the content item appears to the user to be centered in front of the user.

10. The method of claim 1, further comprising:
based on the second change to the position of the content item, shifting the content item left or right.

11. The method of claim 1, wherein the content item is a two-dimensional (2D) window.

12. A head mounted device (HMD) comprising:
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
presenting a view of a content item at a position and an orientation within a three-dimensional (3D) environment;
obtaining a first change to the orientation of the content item within the 3D environment;
obtaining a second change to the position of the content item with the 3D environment;
determining a characteristic of a user-specific forward direction based on the first change to the orientation and the second change to the position of the content item; and
presenting additional content within one or more 3D environments based on the characteristic of the user-specific forward direction.

13. The HMD of claim 12, wherein said presenting the view of the content item at the position and the orientation comprises:
determining an eye center based on sensor data from one or more sensors of the HMD, wherein the eye center is a center position between eyes of a user wearing the HMD;
determining an eye-forward direction based on the eye center; and
determining the position and the orientation, of the content item within the 3D environment, based on the eye-forward direction.

14. The HMD of claim 12, wherein said presenting the view of the content item at the position and the orientation comprises:
determining a device-forward direction based on a position of the HMD; and
determining the position and the orientation, of the content item within the 3D environment, based on the device-forward direction.

15. The HMD of claim 12, wherein said determining the characteristic of the user-specific forward direction comprises determining a difference between a device-based forward direction and the user-specific forward direction.

16. The HMD of claim 12, wherein said determining the characteristic of the user-specific forward direction comprises determining a difference between an eye-based forward direction and the user-specific forward direction.

17. The HMD of claim 12, wherein the first change is obtained before the second change.

18. The HMD of claim 12, wherein said obtaining the first change to the orientation comprises:
presenting an instruction for a user to rotate the content item until the content item appears to the user to be facing the user.

19. The HMD of claim 12, further comprising:
based on the first change to the orientation, rotating an original vector used to determine the orientation of the content item; and
reorienting the content item in the view based on the rotated original vector.

20. A non-transitory computer-readable storage medium storing program instructions executable via one or more processors, of a head mounted device (HMD), to perform operations comprising:
presenting a view of a content item at a position and an orientation within a three-dimensional (3D) environment;
obtaining a first change to the orientation of the content item within the 3D environment;
obtaining a second change to the position of the content item with the 3D environment;
determining a characteristic of a user-specific forward direction based on the first change to the orientation and the second change to the position of the content item; and
presenting additional content within one or more 3D environments based on the characteristic of the user-specific forward direction.
